(19) United States
(12) Patent Application Publication
(10) Pub. No.: US 2006/0289613 A1
(43) Pub. Date: Dec. 28, 2006

(54) Mailer

(76) Inventor: Anthony C. Rocco, Selden, NY (US)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/476,511

(22) Filed: Jun. 28, 2006

Related U.S. Application Data
(60) Provisional application No. 60/694,754, filed on Jun. 28, 2005.

(51) Int. Cl. B42D 15/00

(52) U.S. Cl. 229/92.8; 229/300

(57) ABSTRACT

A bi-fold postcard mailer is provided and includes a first postcard having a first face and a second face; a second postcard attached to an edge of the first postcard and having a first face and a second face, wherein the mailer is foldable along the edge; and a label removably affixed to at least one of the first face of the first postcard, the second face of the first postcard, the first face of the second postcard, and the second face of the second postcard, wherein the label is located between the first and second postcard when the mailer is in the folded condition. The removable label covers at least a portion of a writing provided on the second face of the first postcard.

### CROSS-REFERENCE TO RELATED APPLICATION

The present application claims the benefit of and priority to U.S. Provisional Application 60/694,754, filed Jun. 28, 2005, the entire contents of which are incorporated herein by reference.

### BACKGROUND

1. Technical Field

The present disclosure generally relates to postcard mailers and more specifically relates to postcards that have means to hide an outgoing message and that include a return-postcard/reply mechanism.

2. Background of Related Art

It has long been known that an increased rate of response to mail solicitation can be achieved if the original, soliciting mailing includes provisions to simplify the actions required by the recipient in responding to the original mailing. Thus, such mailings conventionally employ return-envelopes, return-postcards, etc., which may be a courtesy reply, where the recipient applies the postage, or a BRM, which is where the postage is pre-paid by the sender.

Indeed, with the advent of mailers as proposed in, for example, U.S. Pat. No. 3,104,799, virtually an entire new industry was created.

While mailers of the type disclosed in U.S. Pat. No. 3,104,799 have been very successful for their intended purpose, they are basically envelope-type mailers provided with return-envelopes and thus may be more expensive to manufacture and more expensive to post than is necessary in those instances where postcard-type assemblies could be used.

It is, of course, known to provide so-called “two-way” or bi-fold postcards. In a typical two-way postcard, a single piece of card stock of twice the size of an ordinary postcard is folded in half upon itself and the edges remote from the fold of the two resulting pieces are adhered (e.g., stapled, wafer sealed, glued or other means of affixing together in accordance with postal regulations and guidelines) together. United States Postal Service (USPS) regulations, however, require that at least one side of the postcard must not be sealed. On one of the interior-facing surfaces, a return mailing address together with a courtesy reply or BRM may be provided. The other interior-facing surface may contain a personal correspondence with some of the recipient's personal information. An exterior surface may include a mailing address receiving area as well as a franking area. The other exterior surface may be provided with requested information, a data request, etc.

The postcard is mailed to a recipient who will hopefully respond to the requested information, break the adhered connection between the pieces and either reverse-fold the card and readhere (e.g., staple) the same to expose the return address while hiding the original address or simply remove and discard the piece bearing the original address. This would result in a return-postcard bearing only the return address and the data. This type of mailer, however, does not hide the general and/or personal correspondence on an interior surface of the mailer because of the USPS regulation which requires that at least one side of the mailer must not be adhered or sealed closed (i.e., it must be open).

It would be advantageous to provide a two-way postcard having the ability to maintain the privacy of the recipient by hiding his or her personal information.

### SUMMARY

The present disclosure generally relates to postcard mailers that have means to hide an outgoing message and that include a return-postcard/reply mechanism.

According to an aspect of the present disclosure, a mailer is provided including an original postcard having a first face and a second face. The original postcard includes at least one of a recipient's address, a sender's address, a franking position, and a machine readable marking provided on the first face thereof; a writing provided on the second face of the original postcard; and a selectively removable label affixed to the second face of the original postcard, wherein the removable label covers at least a portion of the writing provided on the second face of the original postcard.

The mailer may include a return postcard attached to the original postcard along a side edge thereof and defining a separation line therealong.

The return postcard may include a first face and a second face. Accordingly, when the mailer is folded along the separation line the return postcard overlies the second face of the original postcard. In one embodiment, the first face of the return postcard may be adjacent the second face of the original postcard when the mailer is folded along the separation line.

The return postcard may be selectively affixed to the second face of the original postcard along an edge opposite the separation line. The original and return postcards may be selectively affixed to one another along side edges thereof.

The second face of the return postcard may include a writing provided thereon. The first face of the return postcard may include at least one of an address, a franking position, a machine readable marking, a postal marking code, and a return address.

The removable label may be provided on at least one of the first face of the return postcard and the second face of the original postcard.

According to another aspect of the present disclosure, a bi-fold postcard mailer is provided. The bi-fold mailer postcard includes a first postcard having a first face and a second face; a second postcard attached to an edge of the first postcard and having a first face and a second face, wherein the mailer is foldable along the edge, the mailer having a folded condition wherein one of the first and second faces of the first postcard is adjacent one of the first and second faces of the second postcard; and a label removably affixed to at least one of the first face of the first postcard, the second face of the first postcard, the first face of the second postcard, and the second face of the second postcard, wherein the label is located between the first and second postcard when the mailer is in the folded condition.

The first and second postcards may be selectively affixed to one another along an edge opposite to the folded edge between the first and second postcards. The original and return postcards may be selectively affixed to one another along side edges thereof.

The first postcard may include at least one of a recipient's address, a sender's address, a franking position, and a machine readable marking provided on the first face thereof. The first postcard may further include a writing provided on the second face thereof. The second face of the second postcard includes a writing provided thereon.

The first face of the second postcard may be adjacent the second face of the first postcard when the mailer is folded along the folded edge.

The removable label may be provided on at least one of the first face of the second postcard and the second face of the first postcard.

Each of the first and second postcards may have a dimension of about 6 inches by about 4.25 inches.

The removable label may cover at least one of a portion of a writing provided on the second face of the first postcard and at least a portion of an address, a franking position, a machine readable marking, a postal marking code, and/or a return address provided on the first face of the second postcard.

The removable label may be affixed to the first postcard when the postcard mailer is first transmitted; and the removable label may be affixed to the second postcard when the second postcard is separated from the first postcard and the second postcard is transmitted. The removable label may overlie at least a portion of a writing provided on the second postcard.

### BRIEF DESCRIPTION OF THE DRAWINGS

Several embodiments of the presently disclosed mailer are described herein with reference to the drawings, wherein:

FIG. 1 is an exterior view of a postcard mailer in accordance with this disclosure;

FIG. 2 is an interior view of the postcard mailer of FIG. 1;

FIG. 3 is a front perspective view of the postcard mailer of FIGS. 1-2 illustrated in a folded and sealed position, shown with the postcards separated from one another and with an optional wafer seal;

FIG. 4 is a rear perspective view of the postcard mailer of FIGS. 1-3 illustrated in a folded and sealed position, shown with the postcards separated from one another and with an optional wafer seal;

FIG. 5 is an interior view of a panel of the postcard mailer of FIGS. 1-4 illustrating a label partially peeled away;

FIG. 6 is an interior view of the postcard mailer of FIGS. 1-5;

FIG. 7 is a front view of a postcard mailer with optional perforation lines disposed on the sides of the postcard mailer;

FIG. 8 is a front perspective view of the postcard mailer of FIG. 7 illustrated in a folded and sealed position;

FIG. 9 is a perspective view of a postcard mailer illustrated with perforations near its top and bottom edges and in a partially-folded condition;

FIG. 10 is a side view of the postcard mailer of FIG. 9, illustrated in a folded position, with the original and return postcards bowed outwardly;

FIG. 11 is a plan view of a first side of a postcard mailer according to another embodiment of the present disclosure;

FIG. 12 is a plan view of a second side of the postcard mailer of FIG. 11; and

FIG. 13 is a plan view of the second card of the postcard mailer of FIGS. 11 and 12, shown with the label of the first postcard affixed thereto.

### DETAILED DESCRIPTION

Referring now in specific detail to the drawings in which like referenced numerals identify similar or identical elements throughout the several views. In the following description, well-known functions are not described in detail to avoid obscuring the disclosure in unnecessary detail.

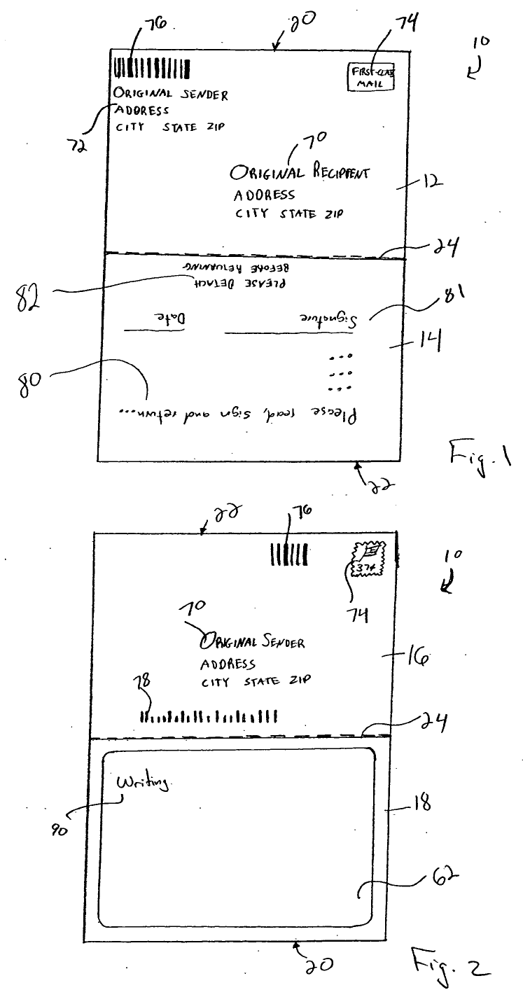

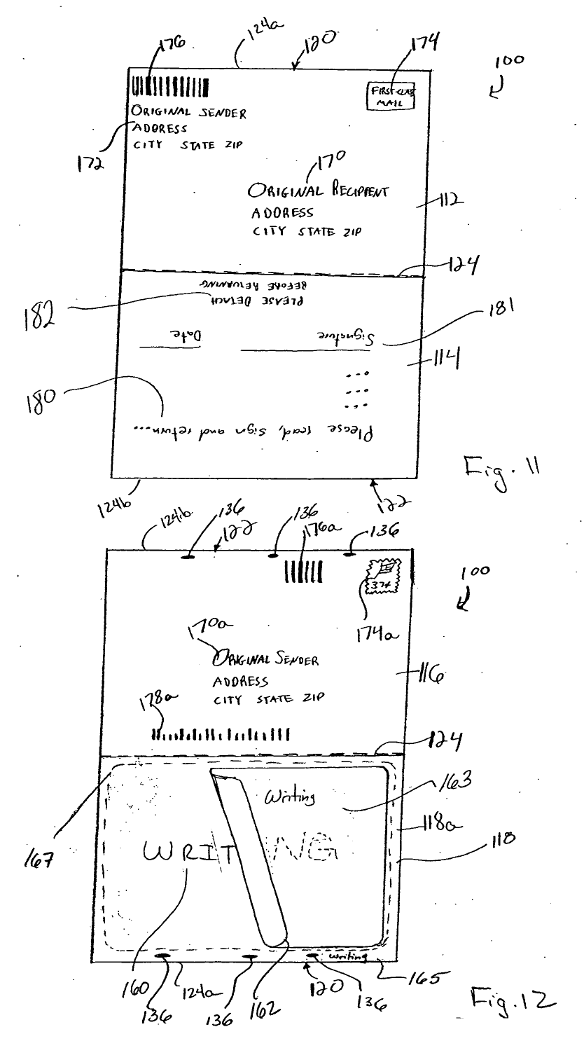

A postcard mailer 10 of the disclosure is shown in FIGS. 1-10. The postcard mailer 10 is generally a single piece of paper approximately twice the size of a typical postcard (e.g., about 6″ by about 4.25″) and is folded in half upon itself to form a typically-sized postcard (See FIGS. 3, 4, 8 and 10). The postcard mailer 10 allows an original sender to mail an original postcard 20 and a return-postcard 22 to a recipient while only having to pay the fee of mailing a single postcard. When receiving the postcard mailer 10, the recipient then usually detaches the return-postcard 22, enters information thereon, and mails the return-postcard 22 back to the original sender or to someone else.

The postcard mailer 10 includes four faces, i.e., a first face 12, a second face 14, a third face 16 and a fourth face 18. The first face 12 and the fourth face 18 comprise the original postcard 20, such that the fourth face 18 is on the reverse side of the first face 12. The second face 14 and the third face 16 comprise the return-postcard 22, such that the third face 16 is on the reverse side of the second face 14. A perforation line 24 defines the border or boundary between the connected original postcard 20 and return-postcard 22. When the postcard mailer 10 is folded along the perforation line 24 (FIGS. 3, 4, and 8-10), the first face 12 and the second face 14 are facing the exterior, while the third face 16 and the fourth face 18 are interior facing. FIGS. 3, 4, 8 and 10 show the postcard mailer 10 in a substantially tubular orientation for illustrative purposes.

As seen in FIGS. 1 and 3, the first face 12, an exterior face, of original postcard 20 may include a recipient's address 70, a sender's address 72 in a return address position, a franking or position for a stamp 74 or meter, and a facing identification marker (FIM) or a machine readable marking (including planet code, barcode, Aztec code, 2D bar codes, 3D bar codes, etc.) 76. As seen in FIGS. 1, 4 and 7, the second face 14, an exterior face that gets returned to the sender, of the return-postcard 22 may include wording 80, such as, for example, a wording for a voter proxy, and a signature line 81. The second face 14 of the return-postcard 22 may also include instructions 82 guiding the recipient to detach the original postcard 20 from the return-postcard 22 before mailing the return-postcard 22 back to the sender.

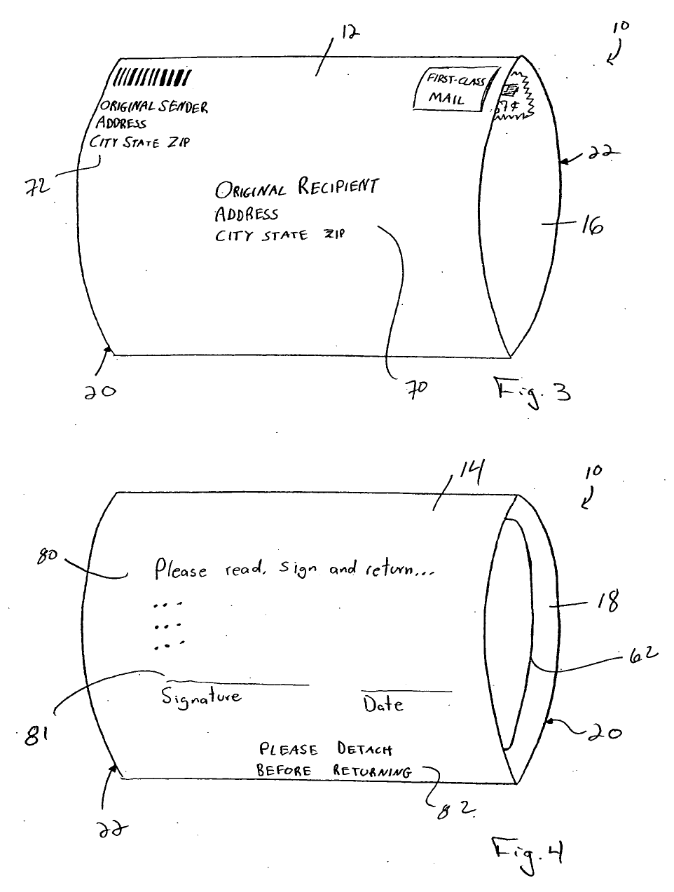

As seen in FIGS. 2, 6 and 9, the third face 16, an interior face, of the return-postcard 22 is part of the return-postcard 22 of the postcard mailer 10 and is mailed to the sender or to the designated address. The third face 16 may include the sender's address 72 or other designated address, a franking or position for a stamp 74, a machine readable marking 76, a postal marking code 78 and the recipient's address 70 in the return address position (not shown). As seen in FIGS. 2 ,5, 6 and 9, the fourth face 18, an interior face, of the original postcard 20 may include a writing 60 covered by a cover in the form of a peel-away label or piggy-back label 62, optionally with transparent backing. Additionally, the piggy-back label 62 may include a writing 90, perhaps instructing the recipient to peel off the piggy-back label 62 to view information.

While this description describes the contents of each face of the postcard mailer 10, it can be appreciated and is within the scope of this disclosure for some of the content to be on different faces other than those described, while still conforming to the spirit of this disclosure.

The United State Postal Service (USPS) has certain regulations for mailpiece designs. One such regulation relates to the need to have at least one open end when mailing a two-way postcard, i.e., all four sides cannot be sealed. This regulation ensures that the interior faces 16, 18 of the postcard mailer 10 are optionally visible, as illustrated in FIGS. 3, 4, 8 and 10.

Complying with USPS regulations results in the interior faces 16, 18 being visible and/or accessible when the postcard mailer 10 is in a closed position (see FIGS. 3, 4, 8 and 10). The visibility of the interior faces 16, 18 of the postcard mailer 10 can create a concern if the writing 60 on the fourth face 18 contains personal information where maintaining the recipient's privacy is important. To maintain the privacy of the recipient, the disclosed postcard mailer 10 includes a peel-off label or piggy-back label 62 at least partially covering the confidential writing 60. This label 62 can be appreciated in all instances where a sender wants to mail a two-way postcard with personal or confidential information to a recipient. Such instances can include debt collecting, pin number verification, password verification, account balance information, messages containing social security numbers, etc.

To maintain the postcard mailer 10 sealed in a folded position, different methods of sealing may be employed. As best illustrated in FIGS. 6, 9 and 10, top edge 30 of third face 16 and/or bottom edge 32 of fourth face 18 may contain a line, bead(s), or strip of adhesive 36. The adhesive 36 can be made from any reasonable and suitable material which enables selective adherence of the original postcard 20 to the return-postcard 22. The adhesive 36 seals the original postcard 20 to the return-postcard 22 when the postcard mailer 10 is folded along its perforated fold 24. It is also envisioned that adhesive 36 can be disposed on a left side 40 and/or a right side 42 of postcard mailer 10, as illustrated in FIGS. 7 and 8.

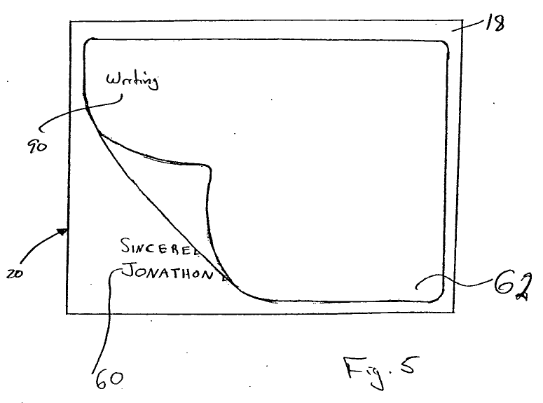

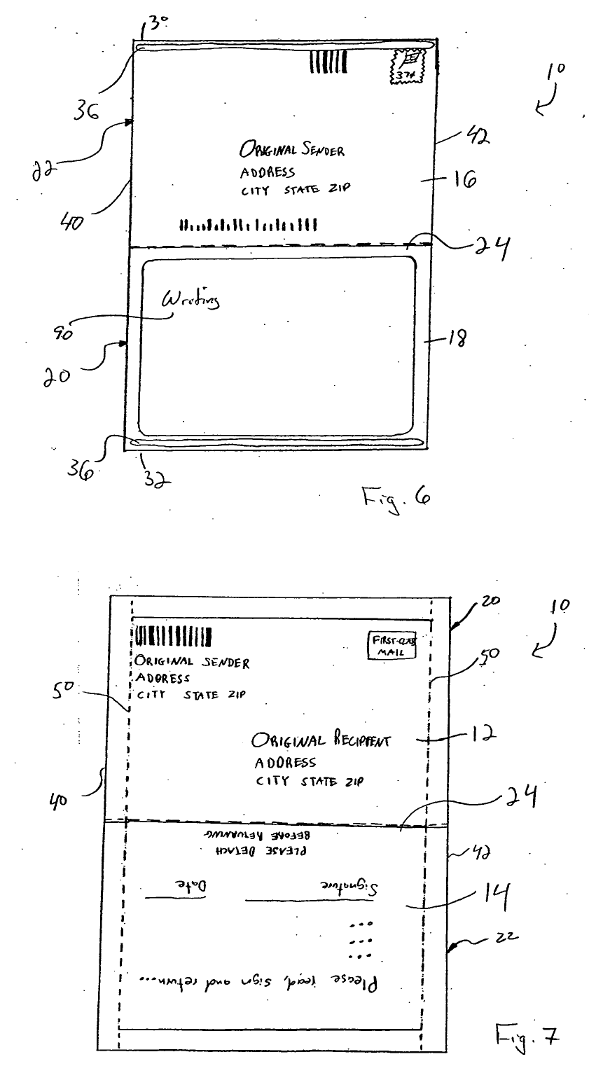

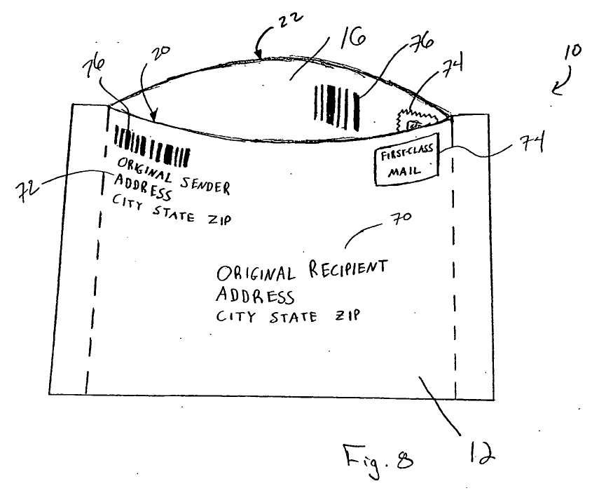

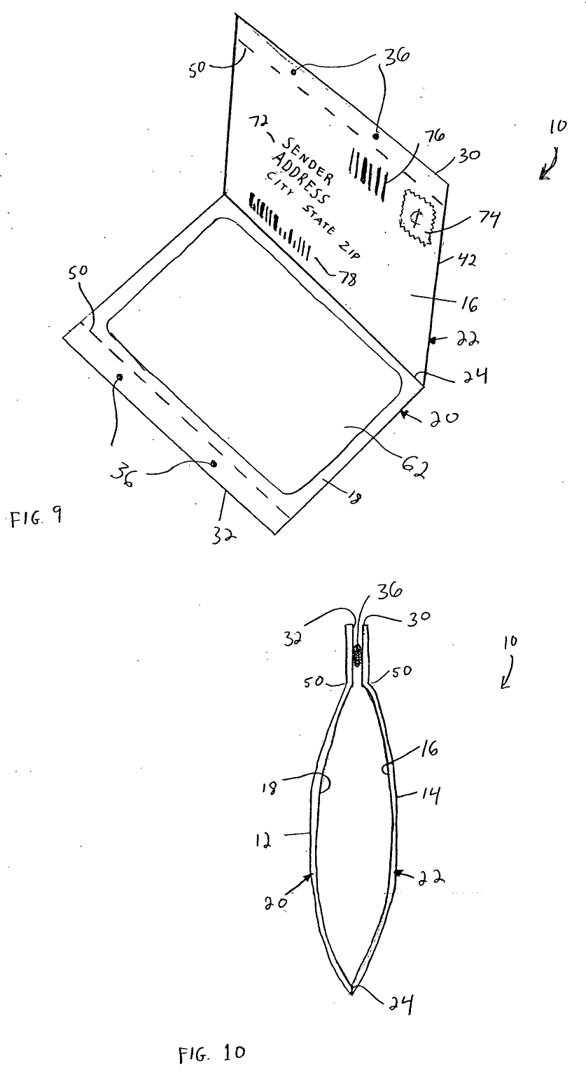

As illustrated in FIG. 7, other more permanent sealing means, including perforations 50 disposed near either side 40 and/or 42 of the postcard mailer 10, can also be used to adhere the original postcard 20 to the return-postcard 22 (illustrated in conjunction with adhesive 36). It is envisioned that the perforations 50 can also be disposed at or near the top 30 and/or bottom 32 of postcard mailer 10 to create a seal therebetween. It is contemplated that any combination of use of adhesives and perforations along with other sealing means, such as staples, adhesive tape, adhesive stickers, wafer seals “W” (see FIGS. 3 and 4) etc., both individually and in combination with one or more of the disclosed sealing means may be provided.

In use, when a recipient receives the postcard mailer 10, he or she can break the seal(s) made by the adhesive 36, perforation(s) 50 and/or wafer seal “W.” The recipient can then peel off the label 62 to reveal information printed therebetween. The recipient can then fill out the return-postcard 22, detach the return-postcard 22 from the original postcard 20, and mail the return-postcard 22 to the address appearing on the return-postcard 22 (or to anyone else). It is also appreciated that these steps can be accomplished in any reasonable order.

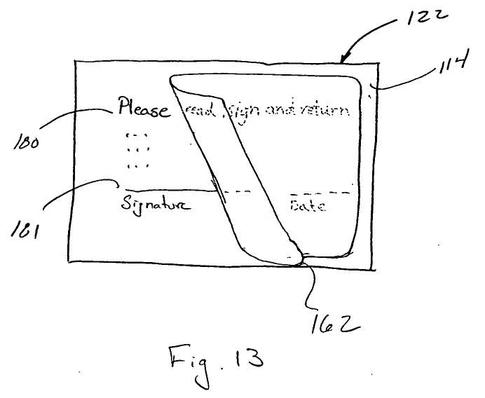

Turning now to FIGS. 11 and 12, a postcard mailer according to another embodiment of the present disclosure is generally designated as 100. Postcard mailer 100 is substantially similar to postcard mailer 10 and thus will only be discussed in detail herein to the extent necessary to identify differences in construction and operation.

As seen in FIGS. 11 and 12, postcard mailer 100 includes a first or original postcard 120 and a second or return postcard 122 secured to first postcard 120 along a fold and/or separation line 124. First postcard 120 includes a first face 112 and a second, opposite face 118. Second postcard 122 includes a first face 114 and a second, opposite face 116.

As seen in FIG. 11, first face 112 of first postcard 120 may include a recipient's address 170, a sender's return address 172, a franking or position for a stamp or meter 174 and an FIM or other machine readable marking 176. As seen in FIG. 12, second face 118 of first postcard 120 may include a writing 160 in the form of text, images or the like provided thereon, and a selectively affixable/removable label 162 adhered thereto, over writing 160. Label 162 may be at least partially opaque so as to cover at least portions of writing 160 and not render said portions visible. In one embodiment, label 162 may be entirely opaque. Label 162 may be a piggy-back label or the like. Second face 118 of first postcard 120 may include a transparent polymeric film 167 provided over writing 160 onto which label 162 is affixed. In one embodiment, writing 160 may be provided on the polymeric film.

As seen in FIG. 12, label 162 may include a writing 163 provided on a surface thereof, such as, for example, instructions for the recipient to follow and the like. In one embodiment, label 162 may include a writing 163 instructing the recipient to remove label 162 from first postcard 120, to reapply label 162 to either first or second face 114, 116 of second postcard 122, to complete a number of questions (i.e., provide the recipients address, etc.) and/or to complete a number of tasks. In one embodiment, an edge 118a of second surface 118, defined as the area of second surface 118 between label 162 and an outer-most edge of first postcard 120, includes writing 165, in the form of instructions, provided thereon.

As seen in FIG. 11, first face 114 of second postcard 122 may include a writing 180 in the form of text, images or the like provided thereon. For example, writing 180 may include information relating to a voter proxy, credit information, other personal information and the like, as well as, an optional signature line 181. Also, first face 114 of second postcard 122 may include a writing 182 in the form of instructions or the like providing the recipient with directions for accomplishing or performing certain tasks. As seen in FIG. 12, second face 116 of second postcard 122 may include a sender's address 170a or other designated address, a franking or position for a stamp or meter 174a, an FIM or other machine readable marking 176a and/or a postal marking code 178a.

Postcard mailer 100 is foldable along fold/separation line 124 such that second face 118 of first postcard 120 is adjacent second face 116 of second postcard 122. Postcard mailer 100 includes a contact adhesive or other suitable non-permanent, selectively adherable adhesive 136 provided near an edge 124a of first postcard 120 and/or an edge 124b of second postcard 122, wherein edges 124a, 124b are opposite fold/separation line 124. While adhesive 136 is shown and described, it is envisioned that edges 124a, 124b may be taped, stapled, glued or otherwise selectively secured to one another.

In use, postcard mailer 100 is transmitted or mailed while in a folded condition, similar to postcard 10 of FIGS. 3 and 4, wherein second face 118 of first postcard 120 is adjacent second face 116 of second postcard 122 and respective edges 124a, 124b thereof are adhered to one another. In this manner, label 162 is interposed between first and second postcards 120, 122 and overlies at least portions of writing 160. In this manner, second surface 118 of first postcard 120 and second face 116 of second postcard 122 may be viewable from either side edge of postcard mailer 100, in accordance with United States Postal Service regulations.

Upon receipt of postcard mailer 100, by the recipient, second postcard 122 may be separated from first postcard 120 to expose label 162 to the recipient. The recipient may follow the instructions provided on the surface of label 162, or elsewhere on postcard mailer 100. The recipient may fill-in information requested on label 162 and, as seen in FIG. 13, affix label 162 to first face 114 or second face 116 of second postcard 122. The recipient may then transmit and/or mail second postcard 122 to the address provided thereon.

In one embodiment, postcard mailer 100 may include only one of first postcard 120 or second postcard 122. In the interest of economy only postcard mailer 100 including only first postcard 120 will be discussed further herein. It is understood that second postcard 122 may be substantially identical to first postcard 120.

As discussed above, first postcard 120 includes may include a first face 112 and a second face 118, wherein first face 112 includes at least one of a recipient's address 170, a sender's return address 172, a franking or position for a stamp or meter 174 and an FIM and other machine readable marking 176. Second face 118 of first postcard 120 may include a writing 160 in the form of text, images or the like provided thereon, and a selectively affixable/removable cover in the form of a label 162 adhered thereto, wherein label 162 covers or otherwise overlies at least a portion of writing 160.

Label 162 may be at least partially opaque so as to cover at least portions of writing 160 and not render said portions visible. In one embodiment, label 162 may be entirely opaque. Label 162 may be a piggy-back label or the like. Second face 118 of first postcard 120 may include a transparent polymeric film 167 provided over writing 160 onto which label 162 is affixed. In one embodiment, writing 160 may be provided on the polymeric film.

Label 162 may include a writing 163 provided on a surface thereof, such as, for example, instructions for the recipient to follow and the like. In one embodiment, label 162 may include a writing 163 instructing the recipient to remove label 162 from first postcard 120, to reapply label 162 to either first or second face 114, 116 of second postcard 122, to complete a number of questions (i.e., provide the recipients address, etc.) and/or to complete a number of tasks. In one embodiment, an edge 118a of second surface 118, defined as the area of second surface 118 between label 162 and an outer-most edge of first postcard 120, includes writing 165, in the form of instructions, provided thereon.

In use, postcard mailer 100, including solely first postcard 120 and label 162 affixed thereto, is transmitted or mailed to a recipient. Upon receipt of first postcard 120, by the recipient, the recipient may follow the instructions provided on the surface of label 162, or elsewhere on first postcard 120, such as for example, to remove label 162 from first postcard 120. The recipient may then, if needed, fill-in information requested on first postcard 120, beneath label 162, return first postcard 120 to the sender or forward to another designated address. Alternatively, the recipient may fill-in information requested which was provided on the back of label 162, and re-affix label 162 to an opposite side of first postcard 120 and once again return first postcard 120 to the sender or forward to another designated address. It is contemplated that the sender's address or the other designated address may have been originally provided beneath label 162 when label 162 was on second face 118 of first postcard 120.

Although the illustrative embodiments of the present disclosure have been described herein with reference to the accompanying drawings, it is to be understood that the disclosure is not limited to those precise embodiments, and that various other changes and modifications may be affected therein by one skilled in the art without departing from the scope or spirit of the disclosure. For example, a piggy-back label can be employed to cover the second face of the postcard mailer. For another example, card stock or a related material can be used as the material for the original postcard and/or return-postcard of the postcard mailer. For another example, the fold that separates the original postcard from the return-postcard does not have to be a perforated fold and the postcards do not have to detach from one another. In such an embodiment, it is contemplated that when the recipient desires to send the return-postcard, he/she can fold the postcard, such that the sender's address is displayed, and further secure the two postcards with a piece of tape or a staple, for example. For another example, the recipient can cover or re-cover any information on the return postcard with a label. For another example, the original postcard and the return-postcard can be linked by a fold or perforated fold on the sides thereof, rather than the top and bottom thereof. For another example, the return-postcard can be pre-addressed to someone other than the original sender or it could contain no address at all. For yet another example, the mailer need not be used as a postcard, but it can be used as an envelope-mailer or insert.

What is claimed is:

1. A mailer, comprising:
an original postcard having a first face and a second face, the original postcard including:
at least one of a recipient's address, a sender's address, a franking position, and a machine readable marking provided on the first face thereof;
a writing provided on the second face of the original postcard; and
a selectively removable label affixed to the second face of the original postcard, wherein the removable label covers at least a portion of the writing provided on the second face of the original postcard.

2. The mailer according to claim 1, further comprising a return postcard attached to the original postcard along a side edge thereof and defining a separation line therealong.

3. The mailer according to claim 1, wherein the return postcard includes a first face and a second face, wherein when the mailer is folded along the separation line the return postcard overlies the second face of the original postcard.

4. The mailer according to claim 3, wherein the return postcard is selectively affixed to the second face of the original postcard along an edge opposite the separation line.

5. The mailer according to claim 4, wherein the second face of the return postcard includes a writing provided thereon.

6. The mailer according to claim 5, wherein the first face of the return postcard is adjacent the second face of the original postcard when the mailer is folded along the separation line.

7. The mailer according to claim 4, wherein the first face of the return postcard includes at least one of an address, a franking position, a machine readable marking, a postal marking code, and a return address.

8. The mailer according to claim 2, wherein the original and return postcards are selectively affixed to one another along side edges thereof.

9. The mailer according to claim 6, wherein the removable label is provided on at least one of the first face of the return postcard and the second face of the original postcard.

10. A bi-fold postcard mailer, comprising:
a first postcard having a first face and a second face;
a second postcard attached to an edge of the first postcard and having a first face and a second face, wherein the mailer is foldable along the edge, the mailer having a folded condition wherein one of the first and second faces of the first postcard is adjacent one of the first and second faces of the second postcard; and
a label removably affixed to at least one of the first face of the first postcard, the second face of the first postcard, the first face of the second postcard, and the second face of the second postcard, wherein the label is located between the first and second postcards when the mailer is in the folded condition.

11. The bi-fold mailer according to claim 10, wherein the first and second postcards are selectively affixed to one another along an edge opposite to the folded edge between the first and second postcards.

12. The bi-fold mailer according to claim 11, wherein the first postcard includes at least one of a recipient's address, a sender's address, a franking position, and a machine readable marking provided on the first face thereof.

13. The bi-fold mailer according to claim 12, wherein the first postcard includes a writing provided on the second face thereof.

14. The bi-fold mailer according to claim 10, wherein the second postcard is selectively affixed to the second face of the first postcard along an edge opposite the folded edge.

15. The bi-fold mailer according to claim 14, wherein the second face of the second postcard includes a writing provided thereon.

16. The bi-fold mailer according to claim 15, wherein the first face of the second postcard is adjacent the second face of the first postcard when the mailer is folded along the folded edge.

17. The bi-fold mailer according to claim 14, wherein the first face of the second postcard includes at least one of an address, a franking position, a machine readable marking, a postal marking code, and a return address.

18. The bi-fold mailer according to claim 10, wherein the original and return postcards are selectively affixed to one another along side edges thereof.

19. The bi-fold mailer according to claim 16, wherein the removable label is provided on at least one of the first face of the second postcard and the second face of the first postcard.

20. The bi-fold mailer according to claim 10, wherein each of the first and second postcards have a dimension of about 6 inches by about 4.25 inches.

21. The bi-fold mailer according to claim 10, wherein the removable label covers at least one of:
at least a portion of a writing provided on the second face of the first postcard; and
at least a portion of at least one of an address, a franking position, a machine readable marking, a postal marking code, and a return address provided on the first face of the second postcard.

22. The bi-fold mailer according to claim 10, wherein the removable label is affixed to the first postcard when the postcard mailer is first transmitted; and
the removable label is affixed to the second postcard when the second postcard is separated from the first postcard and the second postcard is transmitted.

23. The bi-fold mailer according to claim 22, wherein the removable label overlies at least a portion of a writing provided on the second postcard.
